(19) United States
(12) Patent Application Publication
(10) Pub. No.: US 2014/0134425 A1
(43) Pub. Date: May 15, 2014

(54) APPARATUS AND METHOD FOR COATING REACTIVE POLYMER PRE-PREGS

(71) Applicant: Marcel J. Schubiger, Galgenen (CH)

(72) Inventor: Marcel J. Schubiger, Galgenen (CH)

(73) Assignee: IQ TEC SWITZERLAND GMBH, Galgenen (CH)

(21) Appl. No.: 14/129,826

(22) PCT Filed: Jun. 26, 2012
(86) PCT No.: PCT/IB2012/053233

§ 371 Date: Dec. 27, 2013

Related U.S. Application Data
(60) Provisional application No. 61/501,639, filed on Jun. 27, 2011.

(51) Int. Cl. C09D 175/04; C09D 167/00; C09D 133/00; C09D 163/00

(52) U.S. Cl. CPC C09D 175/04; C09D 163/00; C09D 167/00; C09D 133/00
USPC 428/323; 428/411.1; 428/537.1; 428/457; 428/339; 524/590; 523/400; 524/599; 524/556

(57) ABSTRACT

A method and apparatus for coating reactive polymer pre-impregnated reinforcement material (prepregs). The method comprising continuously applying particles of a reactive thermoplastic resin to a first surface of a porous substrate, followed by continuously coating the reactive polymer prepreg. An apparatus for coating reactive polymer pre-impregnated reinforcement material (prepregs), comprising: feeder roll(s) of reinforcement material, receiver roll(s) of drapable polymer pre-impregnated reinforcement material, a conveyor belt having the reinforcement material from the feeder roll thereon, and deposition units for depositing the coating.

### FIELD OF THE INVENTION

The present invention relates generally to powder paint coating of a sheet material. More specifically, the present invention relates to an apparatus and method for distributing the powder on the surface of the material, and the temperatures used in the melting and curing of the powder.

### BACKGROUND

Powder coating is a type of coating that is applied as a free-flowing, dry powder. The main difference between a conventional liquid paint and a powder coating is that the powder coating does not require a solvent to keep the binder and filler parts in a liquid suspension form.

There is a need for improved powder coating devices and methods of using the devices.

### SUMMARY OF THE INVENTION

A first aspect of the present invention provides a coating on a substrate, comprising: a substrate, wherein a temperature of a first surface of the substrate is greater than ambient temperature, and wherein the first surface of the substrate is not grounded; and a coating of powder particles on the ungrounded first surface of the substrate.

A second aspect of the present invention provides a coating on a substrate, comprising: a substrate, wherein the substrate has a first surface; a coating, comprising: a layer of powder particles on the first surface, wherein the powder particles have a neutral charge.

A second aspect of the present invention provides a method for applying powder paint particles to a surface, comprising: directing the powder paint particles to the surface, wherein the powder paint particles have a neutral charge at the time when the particles are applied; and melting the powder paint particles, resulting in forming a uniform coating on the surface.

A third aspect of the present invention provides a method for applying powder particles to a first surface of a substrate, comprising: directing the powder particles to the first surface, wherein the powder particles have a neutral charge at the time when the particles are applied; heating the first surface above ambient temperature; and melting the powder particles, resulting in forming a uniform coating on the surface, wherein uniform coating is defined as a finish having few surface defects.

A fourth aspect of the present invention provides a coating apparatus, comprising: a powder sprinkler, comprising: a means for depositing powder paint to a surface of a substrate using gravity,a means for discharging electrostatic charge on the powder paint, resulting in an electrically neutral powder paint; a means for controlling the rate of deposition of the powder paint: and an electrostatic eliminator.

A fifth aspect of the present invention provides a method for applying powder particles to a first surface of a substrate, comprising: directing the powder particles to the first surface, wherein the first surface is ungrounded at the time when the particles are applied, and wherein the ungrounded first surface has a temperature above ambient temperature when the particles are applied; and melting the powder particles, resulting in forming a uniform coating on the surface, wherein uniform coating is defined as a finish having few surface defects.

### BRIEF DESCRIPTION OF THE DRAWINGS

FIG. 1 depicts a flow sheet process and method of applying a coating to a plastic substrate, according to embodiments of the present invention;

FIG. 2 depicts a longitudinal cross-sectional view of an apparatus for applying a coating to a plastic substrate, according to embodiments of the present invention;

FIGS. 3-5 depict a longitudinal cross-sectional view of an apparatus for applying a coating to a plastic substrate, according to embodiments of the present invention;

FIG. 6 depicts an elevation view of an apparatus for applying powder particles to a first surface of a substrate, according to embodiments of the present invention;

FIG. 7 depicts an elevation view of a coating apparatus, according to embodiments of the present invention; and

FIG. 8 depicts an elevation view of an apparatus for applying powder particles to a first surface of a substrate, according to embodiments of the present invention

### DESCRIPTION OF THE INVENTION

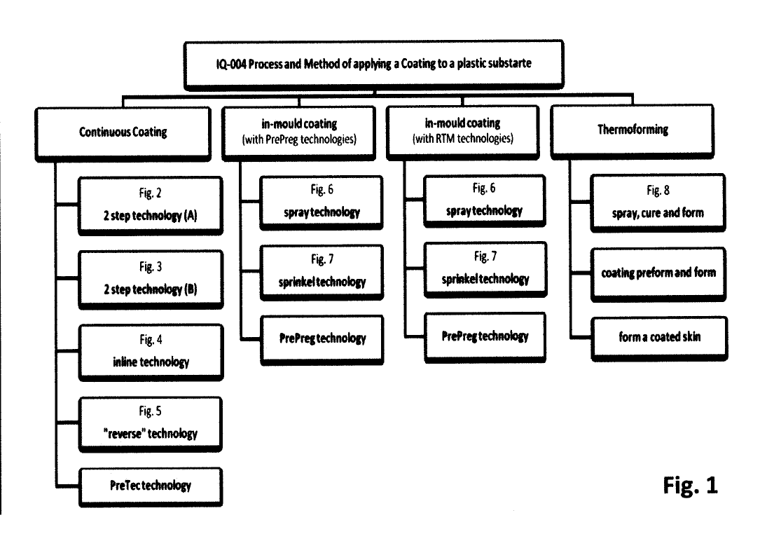

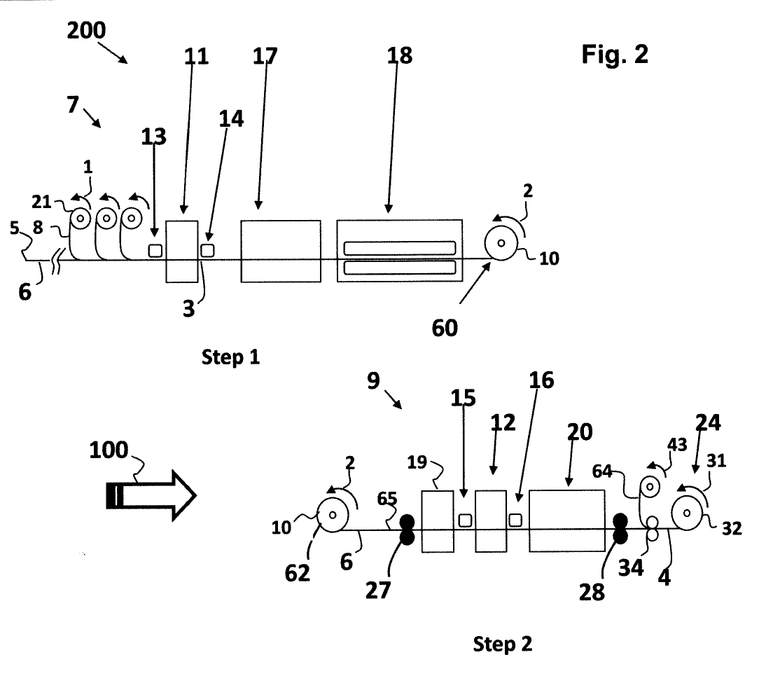

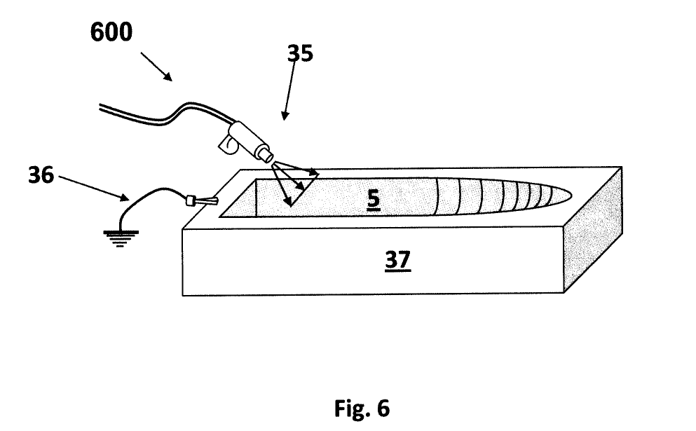

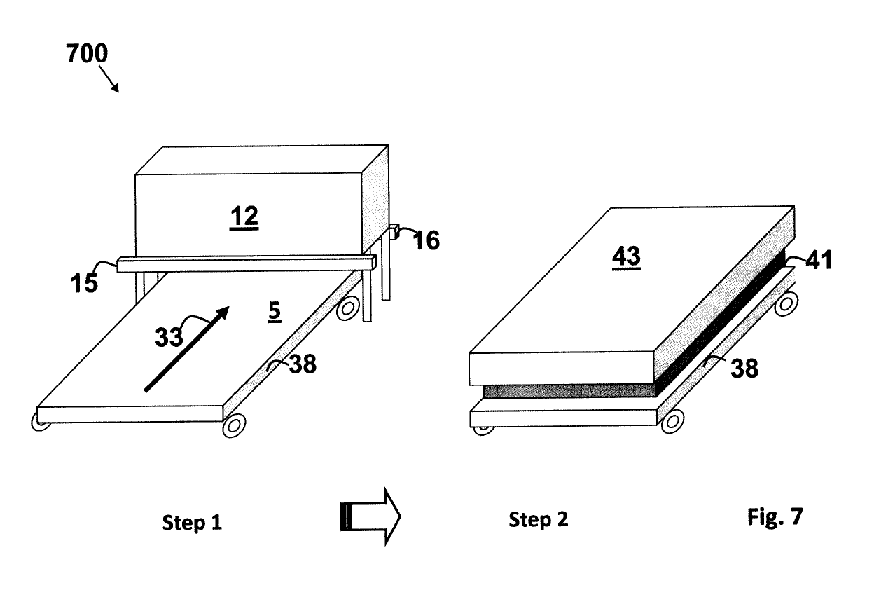

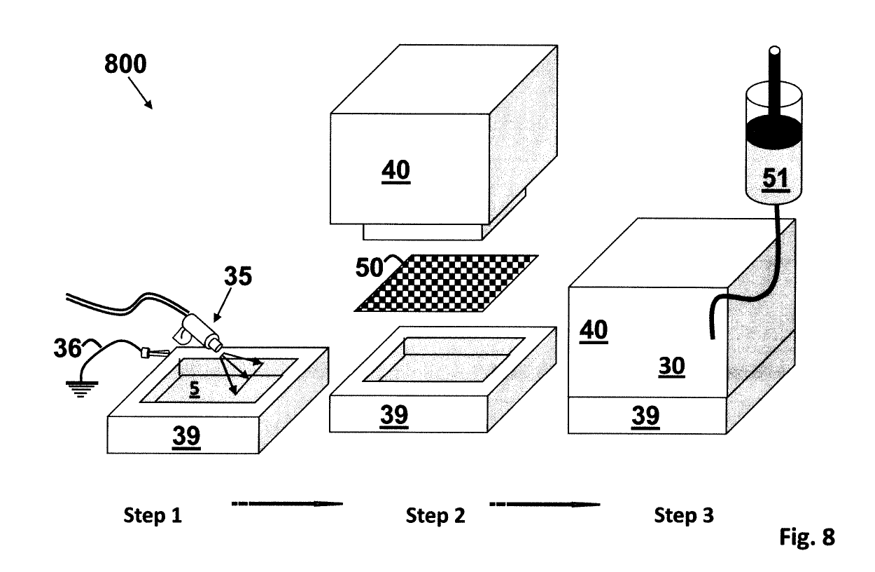

FIG. 1 depicts a flow sheet process and method of applying a coating to a plastic substrate. A continuous coating process and method of applying a coating to a plastic substrate uses coating devices depicted in FIGS. 2-5. An in-mould coating with PrePreg technologies process and method of applying a coating to a plastic substrate uses coating devices depicted in FIGS. 6-7. An in-mould coating with room temperature moulding (RTM) process and method of applying a coating to a plastic substrate uses coating devices depicted in FIGS. 6-7. A thermoforming coating process and method of applying a coating to a plastic substrate uses a coating device depicted in FIG. 8.

FIG. 1 shows a flowchart of the various possibilities for using the current invention. Three defining characteristics of the present invention are:

C1) to coat a substrate with a powdered paint or powdered resin, where the particles of powdered paint or powdered resin are not charged at the time they are deposited, or

C2) to coat a substrate with a powdered paint, where the substrate is not grounded at the time the powder is deposited. Both these features are required in a conventional powder coating process, so removing either one, or both, is unique. Or

C3) adhering a melted and cured (or partially cured) powdered paint coating to a second substrate, on the back side, by having the second substrate bond to the coating, and removing the coating from the first substrate. Resulting in a high quality coating on the second substrate. In typical powder coating the powder melts and bonds to the substrate, not the other way round.

The following are examples to show how these characteristics can be used in different ways, one for each box in FIG. 1, it is by way of example only, these do not intend to cover all aspects and possibilities for the invention.

Continuous Coating

FIG. 2, step 1, 2 Step technology (A): Uses C1 and C2 to coat a porous substrate 8 (e.g. fiberglass fabric) with a powdered resin, which is then heated in a first heating unit 17, the powder melted, and cured completely in a cure and consolidation unit 18, e.g., a double belt press. Then wound up into a spool 60.

FIG. 2, step 2, 2 step technology (B): A laminated substrate 10 wound up in FIG. 2, step 1, is unwound in the direction of the arrow 2, coated with a powder-coat deposition unit 12, applying a powdered paint using C1 and C2, which is melted, flowed, and cured in an oven 20; to produce a powder-coated laminate 23.

FIG. 2, steps 1-2 depict a longitudinal cross-sectional view of an apparatus 200 for applying powder particles to a first surface 5 of a porous substrate 8. The apparatus 200 comprises: a resin deposition stage 7 and a powder particle deposition stage 9.

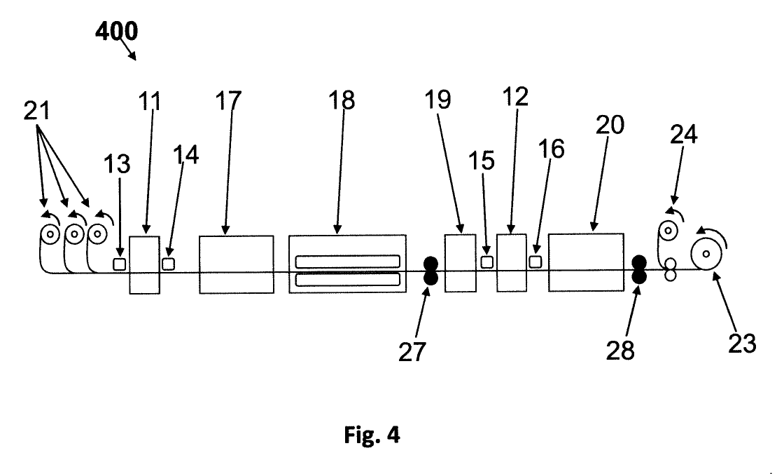

The resin deposition stage 7 has been described in U.S. patent applications Ser. Nos. 12,605,336 and 12/414,241, FIGS. 1 and 4, and associated text, to Marcel J. Schubiger, IQ Tec Switzerland GmbH, Zeughausstrasse 47, CH-8854 Galgenen, Switzerland, and is herein incorporated by reference.

FIG. 2, step 1 depicts the resin deposition stage 7 having a first steel-net conveyor belt 6; at least one supply roll(s) 21 for supplying a porous substrate 8; at least one resin deposition unit(s) 11 charged with particles of reactive (polymerizable) thermoplastic or thermoset resin; and an array of particles of reactive thermoplastic or thermoset resin deposited onto a first surface 3 of the porous substrate 8. The at least one supply roll(s) 21 may unroll by rotating in a direction of the arrow 1 about an axis orthogonal to a plane of the first surface 3 of the porous substrate 8.

The reactive (polymerizable) thermoplastic or thermoset resin are nominally non-electro-conductive, but may be made electro-conductive by including an electro-conductive metal, e.g. steel, stainless steel, brass, copper, aluminum, and alloys of at least two of copper, aluminum, chromium, zinc, manganese and iron in the (polymerizable) thermoplastic or thermoset resin. Alternatively, the reactive (polymerizable) thermoplastic or thermoset resin may be made electro-conductive by including an electro-conductive carbon in the reactive (polymerizable) thermoplastic or thermoset resin.

Reactive (polymerizable) thermoplastic or thermoset resins having melt viscosities between about 5 cp and about 5,000 cp before being cured are commercially available from the Cyclics Corporation, Schenectady, N.Y. USA. Having a very low melt viscosity during processing, enables the reactive (polymerizable) thermoplastic or thermoset resins to impregnate a dense fibrous preform or bed more easily. Upon melting and in the presence of an appropriate catalyst, polymerisation occurs and the reactive (polymerizable) thermoplastic cures to form the laminate.

In one embodiment, the reactive (polymerizable) thermoplastic or thermoset resin may be a blend of a polymerization catalyst and a linear polyester or a linear polyamide, wherein the polymerization catalyst is chosen so that the melt viscosity of the thermoplastic or thermoset resin characterizes its viscosity during the heating and impregnation steps to impregnate the reactive (polymerizable) thermoplastic or thermoset resin into the fiber reinforcement material.

In one embodiment, the reactive (polymerizable) thermoplastic or thermoset resin may be a blend of a polymerization catalyst and a linear poly alkylene terephthalate (where the alkylene has between about 2 and about 8 carbon atoms) or a linear poly alkylene amide (where the alkylene has between about 4 and about 12 carbon atoms).

In one embodiment, the reactive (polymerizable) thermoset resin may be an epoxy resin system such as a bifunctional epoxy (diglycidyl ether of bisphenol-A) matrix system.

In one embodiment, the reactive (polymerizable) thermoset resin may be a reactive (polymerizable) unsaturated polyester resin or epoxy resin. Unsaturated polyester resins (USR) are the third-largest class of thermoset molding resins. The polyesters are low molecular weight viscous liquids dissolved in vinyl monomers like styrene to facilitate molding or shaping of the resin into a desired form before curing to rigid solids. Typical applications are in fiberglass-reinforced shower stalls, boat hulls, truck caps and airfoils, construction panels, and autobody parts and trim. Mineral-filled UPRs are used in synthetic marble countertops and autobody putty. Unfilled UPRs are used in gel coats and maintenance coatings. Adipic acid improves tensile and flexural strength in these resins and, at high levels, can give soft, pliable products for specialty applications. 1-Alkyd resins, a common type of unsaturated polyester resin, utilize adipic acid where low viscosity and high flexibility are valued in plasticizer applications. UPR resins are mainly aromatic polyesters. Flexibility of UPR is increased by replacing a portion of aromatic acid with adipic acid. A cure site monomer, like maleic anhydride, is incorporated to provide unsaturation within the polymer backbone. Crosslinking is by free radical addition polymerization of styrene monomer/diluent.

In one embodiment, the reactive (polymerizable) thermoplastic or thermoset resin may be reactive macrocyclic oligomeric polyester, reactive macrocyclic oligomeric polybutyleneterephthalate, reactive macrocyclic oligomeric polyethyleneterephthalate, reactive macrocyclic oligomeric polycarbonate, and reactive lactam monomers.

In one embodiment, the fiber reinforcement material may be carbon fiber, glass fiber, basalt fiber, and polymer fiber.

In one embodiment, the fibers of the porous substrate 8 may be selected from the group consisting of glass fiber, carbon fiber, aramid fiber, and combinations thereof.

In one embodiment, the apparatus 200 advantageously comprises first and second anti-static bars 13, 14 of an electrostatic eliminator for grounding the array of particles of reactive thermoplastic or thermoset resin deposited onto a first surface 3 of the porous substrate 8, so that the array of of particles of reactive thermoplastic or thermoset resin deposited onto a first surface 3 of the porous substrate 8 have a neutral charge. A Thunderion® low voltage DC anti-static device, available from Simco Nederland B.V., PO Box 71, Aalsvoort 74, 7240 AB Lochem, Netherlands, may advantageously be used to ionize at longer separation distances where classical AC anti-static bars may be insufficient.

The array of the particles of reactive (polymerizable) thermoplastic or thermoset resin may advantageously be deposited onto the first surface 3 of the porous substrate 8, wherein both the particles and the first surface 3 of the porous substrate 8 may be advantageously at ambient temperature in the resin deposition stage 7.

Alternatively, in the resin deposition stage 7, the array particles of reactive (polymerizable) thermoplastic or thermoset resin may advantageously be deposited onto the first surface 3 of the porous substrate 8, wherein only the particles are advantageously at ambient temperature, but the first surface 3 of the porous substrate 8 has been “pre-warmed”, to enable the particles of the reactive thermoplastic or thermoset resin to adhere “immediately” to the first surface 3 of the porous substrate 8. In this embodiment, the inventors report prevention of “rolling away”, or “blowing away” of the particles when they are deposited onto the first surface 3 of the porous substrate 8 by pre-warming the first surface 3 of the porous substrate 8.

The resin deposition stage 7 comprises a first heating unit 17 for providing hot air laminar flow, warming the porous substrate 8 having the array of particles of the reactive (polymerizable) thermoplastic or thermoset resin thereon and the steel net conveyor belt 6. The first heating unit 17 may be any appropriate heating device capable of raising the temperature of the porous substrate 8 between about 190° C. and 220° C. in a residence time between 1 and 5 minutes. The first heating unit 17 may be a convection oven, a drying oven, and IR oven, or conductive heating plates. In this embodiment, the porous substrate 8 may be a fiber reinforcement fabric, a glass mat, or a fiber bed.

The apparatus 200 may optionally be equipped with a cure and consolidation unit 18, e.g., a double belt press, after the first heating unit 17, wherein the cure and consolidation unit 18 may have a hot zone and a cold zone, wherein the hot zone is adapted to receive the polymer pre-impregnated reinforcement material and to heat said pre-impregnated reinforcement material to less than or equal to 250° C. and provide greater than or equal to 1 bar pressure, and wherein the cold zone is adapted to receive the fully impregnated and cured thermoplastic composite sheet and to cool said fully impregnated and cured thermoplastic composite sheet to ambient temperature, or less than or equal to 25° C.

The resin deposition stage 7 comprises: at least one retrieving roll(s) 60 for retrieving the laminated substrate 10, e.g. a pre-preg, after the first surface 5 of the porous substrate 8 has been coated or laminated thereon, wherein the laminated substrate 10 comprises the porous substrate 8 from supply roll(s) 21. The at least one retrieving roll(s) 60 may retrieve the laminated substrate 10, e.g. a pre-preg, by rotating in a direction of the arrow 2 about an axis orthogonal to a plane of the first surface 3 of the porous substrate 8.

FIG. 2, step 2 depicts the powder particle deposition stage 9 of the apparatus 200. Powder coating is a type of dry coating, which is applied as a free-flowing, dry powder. The main difference between a conventional liquid paint and a powder coating is that the powder coating does not require a solvent to keep the binder and filler parts in a liquid suspension form. The coating is typically applied electrostatically and is then cured under heat to allow it to flow and form a “skin.” The powder may be a thermoplastic or a thermoset polymer. It is usually used to create a hard finish that is tougher than conventional paint.

The powder paint coating industry is generally driven to use powders with a small particle size (30-50 microns typical) to, among other requirements, maximize the effects of the electrostatic force on the particles in comparison to the force of gravity, to move them and hold them to the substrate surface.

However the powder coating industry could advantageously use powders having a greater particle size than 30-50 microns. Therefore there is a need for an improved apparatus and method to enable use of powders having a greater particle size than 30-50 microns for coating reactive polymer pre-impregnated reinforcement materials (pre-pregs).

Powder coating may be used for coating of metals, such as “whiteware”, aluminum extrusions, and automobile and motorcycle parts. MDF (medium-density fibreboard) and the laminated substrate 10 of the present invention may be powder coated, using method 100, described herein.

The powder particle deposition stage 9 of the apparatus 200 has first, second, and third sets 27, 28, 34 of clamping or stretching rolls, a second heating unit 19 for pre-heating the laminated substrate 10, a powder-coat deposition unit 12 for depositing an array of powder particles on a first surface 65 of the laminated substrate 10, and a third heating unit 20 for coating cure. The powder-coat deposition unit 12 may be flanked on both sides by first and second anti-static bars 15, 16 of an electrostatic eliminator for grounding the powder coating particles deposited onto a first surface 5 of the porous substrate 8, so that the powder coating particles deposited onto the first surface 65 of the laminated substrate 10 have a neutral charge. A Thunderion® low voltage DC anti-static device, available from Simco Nederland B.V., PO Box 71, Aalsvoort 74, 7240 AB Lochem, Netherlands, may advantageously be used to ionize at longer separation distances where classical AC anti-static bars may be insufficient.

In one embodiment, the second heating unit 19 and third heating unit 20 may be flanked by the first and second sets 27, 28 of clamping or stretching rolls.

The powder particle deposition stage 9 has at least one retrieving roll(s) 32, /for retrieving the powder-coated laminate 23, having a first surface 4, wherein the powder-coated laminate 23 comprises the laminated substrate 10 from supply roll 62, and an optional protective layer 64, thereon. The protective layer 64 may be plastic film or metal foil, supplied by supply roll(s) 24, which may rotate in a direction of the arrow 43 about an axis orthogonal to a plane of the first surface 4 of the powder-coated laminate 23. The at least one retrieving roll(s) 32 may retrieve the powder-coated laminate 23 by rotating in a direction of the arrow 31 about an axis orthogonal to a plane of the first surface 4 of the powder-coated laminate 23.

FIG. 2 depicts a method indicated by arrow 100 for powder-coating the laminated substrate 10, eg. a pre-preg, comprising step 1, continuously applying a reactive (polymerizable) thermoplastic or thermoset resin to a first surface 3 of a porous substrate 8 to be pre-impregnated; and step 2, continuously applying a powder-coating to the first surface 65 of the laminated substrate 10.

The method indicated by arrow 100 comprising the step 1 for continuously applying a reactive (polymerizable) thermoplastic or thermoset resin to a first surface 3 of a porous substrate 8 to be pre-impregnated; and step 2, continuously applying a powder-coating to the first surface 65 of the laminated substrate 10, e.g. prepreg, has been described in U.S. patent applications Ser. Nos. 12,605,336 and 12/414,241, FIGS. 1 and 4, and associated text, to Marcel J. Schubiger, IQ Tec Switzerland GmbH, Zeughausstrasse 47, CH-8854 Galgenen, Switzerland, and are herein incorporated by reference.

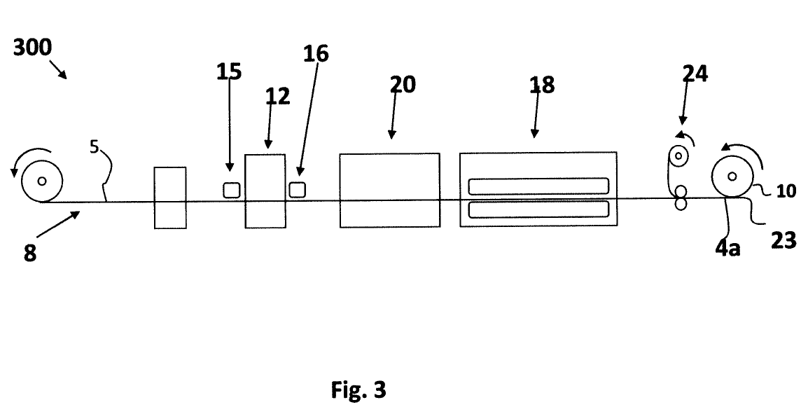

FIG. 3 depicts a longitudinal cross-sectional view of a resin deposition stage or powder coating stage of an apparatus 300. When the apparatus 300 may be a powder particle deposition stage of the apparatus 300 has clamping or stretching roll(s) 24, a heating unit 19 for pre-heating the porous substrate 8 or the laminated substrate 10, a powder-coat deposition unit 12 for depositing a thermoplastic or thermoset resin on the first surface 5 of the porous substrate 8, or depositing an array of powder particles on the laminated substrate 10, and a heating unit 17 for coating cure. The powder-coat deposition unit 12 may be flanked on both sides by first and second 15, 16 anti-static bars of an electrostatic eliminator for grounding the resin particles or powder-coating particles deposited onto a first surface 5, 65 of the porous substrate 8 or the laminated substrate 10, so that the powder coating particles deposited onto a first surface 5 of the coated or laminated substrate 10 have a neutral charge. A Thunderion® low voltage DC anti-static device, available from Simco Nederland B.V., PO Box 71, Aalsvoort 74, 7240 AB Lochem, Netherlands, may advantageously be used to ionize at longer separation distances where classical AC anti-static bars may be insufficient.

When the apparatus 300 may be a powder particle deposition stage of the apparatus 300, it may have at least one retrieving roll(s) 32, for retrieving the powder-coated laminate 23, having a first surface 4a, wherein the powder-coated laminate 23 comprises laminated substrate 10 from supply roll 62, and an optional protective layer 64, thereon. The protective layer 64 may be plastic film or metal foil, supplied by supply roll(s) 24, which may rotate in a direction of the arrow 43 about an axis orthogonal to a plane of the first surface 4a of the powder-coated laminate 23. The at least one retrieving roll(s) 32 may retrieve the powder-coated laminate 23 by rotating in a direction of the arrow 31 about an axis orthogonal to a plane of the first surface 4a of the powder-coated laminate 23.

FIG. 3, 2 step technology: Performs the functions of the first and second resin deposition stages 7, 9 of the machine 200, depicted in FIGS. 2(A), and 2(B), using the machine 300, having parts from the first and second resin deposition stages 7, 9 of the machine 200 in one machine 300. In the two step process 100, in step 1 of the process 100, a laminated substrate 10 may be made with a porous substrate 8 and a powdered resin using C1 and C2, and then wound up in the direction of the arrow 31. In the step 2, the laminate 29 may then be unwound in the direction of the arrow 1 and fed into the machine 300 to apply the powdered paint coating, using C1 and C2, to make the powder-coated laminate 23.

FIG. 4, inline technology: Combines machine functions of FIG. 2, steps 1-2 into one continuous machine 400.

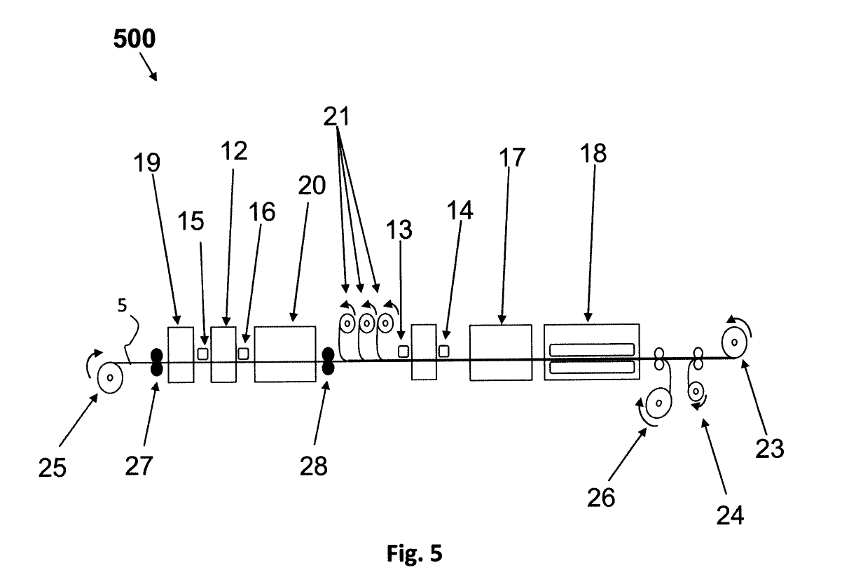

FIG. 5, “reverse” technology: Uses C1 , C2, and C3 to coat a non-porous releasable substrate 25 (e.g. silicone coated PET film) with a powdered resin, which is then heated, the powder melted, flowed, and cured (or partially cured, “B-Staged”). The coated PET film, and powder coating, are then covered with a porous substrate (e.g. fiberglass fabric), then using C1 and C2. A powdered resin is applied, heated, melted and cured to the coating. The PET film is then wound onto roll 26, removed using C3, resulting in a high quality powder-coated laminate 23.

PreTec (or prepreg) technology: PreTec technology consists of applying a powered resin to a porous substrate (e.g. fiberglass fabric) and welting the resin to adhere it to the substrate, and then cool and wind it up, forming a “pre preg”, to be melted and cured at a later time. This prepreg can eliminate the powder deposition step in a variety of processes. The prepreg can be fed directly into the machine in FIG. 5 (for example), in place of the porous substrate and the apparatus to deposit the powder on the substrate porous substrate.

Device 600 for In-Mould Coating (with Pre Preq Technologies)

FIG. 6, spray technology: The application of powder is very simple when the surface 5 of the substrate 37 is electrically non-conductive, such as the surface of the powder-coated laminate 23. Filtered, compressed air, usually at 20-30 psi (137-207 kPa), pushes the powder out of the gun 35 past an electrode which imparts a positive charge to the powder particles. The surface 5 of the substrate 37 being coated may be grounded with grounding strap 36 so the positive powder particles are attracted to the electrically neutral surface 5 of the substrate 37. When the part is completely covered by the powder particles, the grounding strap 36 is removed and the part may be cured in an oven.

In one embodiment, the substrate 37 may not be grounded. The temperature of a first surface 5 of the substrate 37 may be greater than ambient temperature, and the first surface 5 of the substrate 37 is not grounded. In this embodiment, the ungrounded first surface 5 of the substrate 37 is coated with the powder particles thereon.

FIG. 6 depicts two possibilities: 1) Applying a powder coating to a substrate 37 having a first surface 5, e.g., a mold surface, using conventional powder coating equipment, with charged powder and a grounded conductive mold. The mold is then heated to melt, flow, and cure (or partially cure) the coating. C3 is then used to apply a prepreg and cure it to the coating, and removing the cured prepreg and coating together. 2) C1 and/or C2 may be used to coat the mold with a powdered paint, where the mold temperature is high enough to melt the powder so that is stays on the mold surface. The coating is then cured, and transferred to a prepreg using C3, and the part and coating removed from the mold.

FIG. 7, sprinkle technology: Using the apparatus 700, C1 and/or C2, powdered paint is sprinkled by powder-coating deposition unit 12 onto a release surface 5 of a released substrate 38, e.g., a flat mold, as the released substrate 38 is moved through the powder-coating deposition unit 12 in the direction of the arrow 33. The powder paint may be heated (or preheated), melted, flowed and cured (or partially cured) to form a transferrable coating 43. C3 is then used to transfer the coating 43 to a substrate to be coated, 41, e.g. a prepreg. The laminating pressure can be provided by a cure and consolidation unit, e.g., press 18, depicted in FIGS. 2, 3, 4, and 5, and described in associated text.

In-Mould Coating (with RTM Technologies)

FIG. 6, spray technology: Same as In-mould coating (with prepreg technologies) FIG. 6 spray technology, except that the coating is transferred in a resin transfer molding (RTM) process, where the RTM resin adheres to the coating using C3.

FIG. 7, sprinkle technology using the apparatus 700: Same as In-mould coating (with prepreg technologies) FIG. 7 sprinkle technology, except that the coating is transferred in a resin transfer molding (RTM) process, where the RTM resin adheres to the coating using C3

Thermoforming

FIG. 8, spray, cure and form: Using the apparatus 800, in step 1 of a method, C1 and/or C2 are used to apply a powder paint coating to a first surface 5 of a released substrate 37, 38, 39 (e.g. a mold).

In step 1, the mold may be a male or a female “3D curved” Mold (heat able, non-heat able, conductive, non-conductive, . . . ), a male or female “flat, 2D” Mold (heat able, non-heat able, conductive, non-conductive, . . . ), a male (“Piston”) or female (“lower”) Press Mold. The powder is then heated, melted, flowed, and cured in an open mold, as in step 1, or in a closed mold, e.g., the Male Press Mold (“Piston”) 40 (not shown).

In step 2, the pre-heated ready to thermoform substrate 50 is pressed to the coating surface by the Male Press Mold (“Piston”) 40. The cured coating is then adhered to the thermoform substrate 50.

In step 3, a reinforcement web 30 has been overlaid on the thermoform substrate 50 and a melted thermoplastic or thermoset resin has been applied to the thermoform substrate 50 by injection molding 51, using C3. The thermoplastic or thermoset resin is then cooled and solidified, while in contact with the thermoform substrate 50 and the coating; resulting in a coated thermoplastic or thermoset reinforced article of manufacture, e.g. a windblade, an engine cover, or any article of manufacture that replaces heavier parts with high strength, low weight composites.

In one embodiment, the powder particles are powder paint particles.

In one embodiment, the ungrounded first surface 5 of the substrate 37, 38, 39 is a first surface 5 of an article to be coated.

In one embodiment, the ungrounded first surface 5 of the substrate 37, 38, 39 is a release coated mold surface, so that the coating is transferred to a first surface of an article to be coated.

In one embodiment, the ungrounded first surface 5 of the substrate 37, 38, 39 is a release coated film, so that the coating is transferred to a first surface of an article to be coated.

In one embodiment, the melt flow viscosity of the layer of powder particles is less than 3,000 cps. at 180° C.

In one embodiment, the ungrounded first surface 5 of the substrate 37, 38, 39 is selected from the group consisting of a thermoplastic polymer sheet, a thermoset polymer sheet, a wood sheet, and a metal sheet.

In one embodiment, the ungrounded first surface 5 of the substrate 37, 38, 39 has been pre-treated with a mold release agent and the release agent remains on the ungrounded first surface or becomes a first surface of the coating.

In one embodiment, the coating has an average homogeneous thickness of less than 350 μm.

In one embodiment, the powder particles have a particle size from about 50 μm to about 500 μm.

In one embodiment, a D50 of the powder particles is between about 50 microns and 200 microns.

In one embodiment, the powder particles are selected from the group consisting of polyurethane powder particles,polymer powder particles, polyester powder particles, polyester epoxy powder particles, acrylic polymer powder particles, and mixtures thereof.

In one embodiment, the powder particles are inorganic or organic.

In one embodiment, the powder particles are UV curable or thermally curable.

In one embodiment, a coating on a substrate may be a layer of powder particles on the first surface, wherein the powder particles have a neutral charge:

A method for applying powder particles to the first surface 5 of the substrate 10, 25, 30, 37, 38, 39. In a first step of the method, the powder particles are directed to the first surface 5, wherein the powder particles have a neutral charge at the time when the particles are applied. In a second step, the first surface 5 is heated above ambient temperature. In a third step, the powder particles are melted, resulting in forming a uniform coating on the first surface 5. Hereinafter, unless otherwise defined, the term “uniform coating” is defined as a finish having essentially no surface defects.

A coating apparatus 200, 300, 400, 500, 600, 700, and 800, comprising: a non-electrostatic powder particle sprinkler 12, 35, comprising: a means for depositing powder particles to a first surface 5 of a substrate 10, 25, 30, 37, 38, 39, using gravity, or forced air, wherein the non-electrostatic powder particle sprinkler 12, 35, has a means for discharging electrostatic charge of the powder particles, resulting in an electrically neutral powder particle. The coating apparatus may include a means for controlling the rate of deposition of the powder particle. It may include an electrostatic eliminator 15, 16 for eliminating charge on the substrate 10, 25, 30, 37, 38, 39.

In one embodiment, the electrostatic eliminator 15, 16 is a first antistatic bar and second antistatic bar, wherein the first antistatic bar is in proximity of the coated substrate 37, 38, 39, and the second bar is in proximity of the uncoated substrate, 10, 25, 30, wherein the first antistatic bar does not contact the coated substrate.

In one embodiment, the antistatic bar is selected from the group consisting of a brush or a Simko Thunder Ion electrostatic eliminator.

In one embodiment, the means for depositing powder paint includes a needle carpet on a rotating cylinder, with a hopper of powder paint above, wherein a tolerance between the needle tips and the edges of the hopper is directly proportional to particle size, so the powder particles doesn't fall out, and a needle brush has been adapted to remove substantially all the powder paint from the needle bed, and deposited on the underlying substrate.

In one embodiment, a range of the electrostatic eliminator is increased from about 10-30 mm to an enhanced range from about 10-600 mm range.

In one embodiment, a conductive adhesive between the rotating cylinder and the needle carpet may dissipate any electrostatic charge buildup.

In one embodiment, the needle brush is grounded, for dissipating any electrostatic charge buildup

In one embodiment, higher density powder particles are preferred over lower density powder particles when other effects of the higher and lower density powder particles on the finish of the coating are substantially the same.

In one embodiment, the means for controlling the rate of deposition of the powder particles is a precision controlled motor and belt instead of a chain.

In a method for applying powder particles to a first surface 5 of a substrate, 10, 25, 30 37, 38, 39, comprises a first step, directing the powder particles to the first surface 5. The first surface 5 is ungrounded at the time when the particles are applied, and the ungrounded first surface 5 has a temperature above ambient temperature when the particles are applied. In a next step, the powder particles are melted, resulting in forming a uniform coating on the surface, wherein uniform coating is defined as a finish having essentially no surface defects.

The foregoing description of the embodiments of this invention has been presented for purposes of illustration and description. It is not intended to be exhaustive or to limit the invention to the precise form disclosed, and obviously, many modifications and variations are possible.

1. A coating on a substrate, comprising:
a substrate, wherein the substrate has a first surface;
a coating, comprising: a layer of powder particles on the first surface, wherein the powder particles have a neutral charge.

2. The coating of claim 1, comprising a mold release agent on the first surface.

3. The coating of claim 1, comprising a preheated first surface.

4. The coating of claim 1, wherein the melt flow viscosity of the layer of powder particles is less than 3,000 cps. at 180° C.

5. The coating of claim 1, wherein the first surface of the substrate is selected from the group consisting of a thermoplastic polymer sheet, a thermoset polymer sheet, a wood sheet, and a metal sheet.

6. The coating of claim 1, wherein the coating has an average homogeneous thickness of less than 350 μm.

7. The coating of claim 1, wherein the powder particles have a particle size from about 50 μm to about 500 μm.

8. The coating of claim 1, wherein a 050 of the powder particles is between about 50 microns and 200 microns.

9. The coating of claim 1, wherein the powder particles are selected from the group consisting of polyurethane powder particles, epoxy polymer powder particles, polyester powder particles, polyester epoxy powder particles, acrylic polymer powder particles, and mixtures thereof.

10. The coating of claim 1, wherein the powder particles are inorganic or organic.

11. The coating of claim 1, wherein the powder particles are UV curable or thermally curable.

12. The coating of claim 1, wherein the powder particles are powder paint particles.

13-16. (canceled)
